(19) United States
(12) Patent Application Publication
(10) Pub. No.: US 2002/0061744 A1
(43) Pub. Date: May 23, 2002

(54) Controlling wireless, low-power radio frequency network

(75) Inventors: Kai Hamalainen, Tampere (FI); Juha Tuominen, Pirkkala (FI); Matti Vilkko, Tampere (FI)

Correspondence Address: LADAS & PARRY, 26 WEST 61ST STREET, NEW YORK, NY, 10023, US

(73) Assignee: PATRIA AILON OY

(21) Appl. No.: 09/978,844

(22) Filed: Oct. 17, 2001

Related U.S. Application Data
(63) Continuation of application No. PCT/FI01/00500, filed on May 23, 2001.

(30) Foreign Application Priority Data
May 25, 2000 (FI) 20001263

(51) Int. Cl. H04M 3/00

(52) U.S. Cl. 455/426; 455/419

(57) ABSTRACT

A method for controlling a wireless, low-power radio frequency network, and a control device, the network comprising a control device arranged as a master device and at least one slave device subordinated thereto. The master device is arranged to convey control data to the slave device and to receive detection data from the slave device. A data transmission connection is established between the master device and an external terminal via a second telecommunication network, in the master device the received detection data are arranged into a format required by the data transmission protocol used in the data transmission connection to be forwarded to the external terminal and control data from the external terminal to the master device for controlling at least one slave device is conveyed in the format required by the data transmission protocol used on the transmission connection.

### BACKGROUND OF THE INVENTION

This application is a Continuation of International Application PCT/Fl01/00500 filed on May 23, 2001, which designated the U.S.

The invention relates to controlling wireless, low-power radio frequency networks.

To enable cooperation and control, home and office equipment, such as computers and peripherals thereof, copying machines, telecommunication equipment and the like, have conventionally been at least partly interconnected by connection cables. To create a comprehensive and well-operating office system, and to incorporate various devices in the same control system, a large number of connection cables is required between the devices. In addition, limited connecting possibilities make it often very difficult to set up a system of this kind. The number of various portable IT devices and telecommunication devices has recently increased tremendously, and the users utilize the increased applications of the portable devices to a greater extent than before. Hence, these portable devices should be readily connectable to the office system, but it would require more cumbersome connection cables that restrict mobility.

For wireless connection of various portable devices, such as mobile telephones and portable computers, various connections based on infrared links have recently been developed, the most employed of the connections being the one according to the IrDA (Infrared Data Association) specifications. However, infrared connections have many disadvantages: the range of the links is typically short, approximately two meters, the infrared links require accurate alignment and no obstacles are allowed between the transmitter and the receiver, and in addition, the infrared connection can only be established as a point-to-point connection, i.e. only two devices can communicate with one another.

The limitations of the infrared connections can be bypassed by means of a solution based on radio transmitters, in particular so called low-power radio frequency (LPRF) technology. Radio frequency connections have a longer range than infrared connections have, about 10 to 100 m depending on the transmission power, and physical obstacles on the transmission path will not be a problem. In addition, radio frequency connections allow communication between a plurality of devices and the radio transmitter can be controlled to operate independently, without user commands or without aligning the device with a right target.

A number of industrial standards, of which at least Bluetooth and HomeRF are known, have already been developed on solutions based on the low-power radio frequency technology. In addition, various solutions based on wireless local area networks (WLAN), in particular the IEEE 802.11 standard, have been developed for wireless interconnecting of office equipment. So far, Bluetooth has turned out to be technically the most sophisticated and also the most popular of these solutions. Various office equipment and portable devices mutually form a wireless network, which is attached to by means of a Bluetooth module. The Bluetooth module is a microcircuit comprising a radio transmitter, which microcircuit can be integrated with the device or it can be post-mounted as a separate accessory. In a specific space, such as office, the devices attached to the network within the range of the radio transmitter can intercommunicate, whereby a portable computer, for instance, can be operated with a wireless mouse to wirelessly send a file to be outputted by a printer next door. Correspondingly, a mobile station and a portable receiver/microphone headset can form in a vehicle a mutual Bluetooth network, through which audio transmission of the call is transmitted.

In the operation of the Bluetooth network it is essential that, at each moment, any one of the devices attached to the network can act as a master that controls the operation of other devices that are its slaves. For instance, a portable computer can act as the master while it conveys a command to the printer to print out a particular file. Thereafter, it is possible to make such a change that a mobile station which desires to send a stored phone number list to a computer for editing becomes the master. Thus, calls and commands can be sent from each present Bluetooth device attached to the network to any desired device.

Patent application WO98/17032 discloses a wireless low-power network of Bluetooth network type, in which devices, whose operations can be controlled from the Bluetooth network, can be attached to the Bluetooth network via an external telecommunication network. Thus, it is possible to output information from a portable computer via the Bluetooth network and an external telecommunication network to a printer that is located in a different town, for instance.

The above-described arrangement has a problem that the master controlling the operation of the network has to be used within the network service range. This limits the use of wireless networks based on Bluetooth technology to be expanded to various monitoring and control tasks, in particular, such as security arrangements of various spaces or control arrangements of dangerous industrial premises, such as mines or foundries. Centralized control of several Bluetooth networks, for example, in large offices is not possible either, which restricts, for example, large-scale control of calls within the office by utilizing the Bluetooth network.

### BRIEF DESCRIPTION OF THE INVENTION

The object of the invention is to provide a method and equipment implementing the method such that the above-described drawbacks can be solved. This is achieved by the method and device that are characterized by what is disclosed in the independent claims. The preferred embodiments of the invention are disclosed in the dependent claims.

The invention is based on controlling a wireless, low-power radio frequency network, advantageously a Bluetooth network, which comprises a master and slaves such that a telecommunication connection is established from an external terminal device to the master through a second telecommunication network. In the master device, detection data received from the slave devices is arranged in the format required by the telecommunication protocol used in said telecommunication connection and they are forwarded to said external terminal device. From the external terminal device control data is transmitted to the master in the format required by the telecommunication protocol used in the telecommunication connection for controlling the slaves.

An advantage with the method and the device of the invention is that wireless networks can readily be taken into use, for instance, in various monitoring and control tasks, because controlling the network and the devices included therein and processing of detection data received therefrom can be carried out at one point without having to control the master, which controls the operation of the network, within the network service area. The invention also enables centralized control of a plurality of low-power radio frequency networks, whereby calls can be switched to a plurality of different low-power networks, when necessary, in large offices, for instance. A further advantage of the invention is that it enables advantageous wireless remote use of various office equipment or monitoring and control equipment, because one data transmission connection allows controlling of a plurality of devices, whereas in prior art solutions each device typically needs a dedicated wireless connection, e.g. GSM connection, which becomes expensive.

### BRIEF DESCRIPTION OF THE DRAWINGS

In the following, the invention will be described in greater detail in connection with preferred embodiments, with reference to the attached drawings, wherein

FIG. 1 shows a prior art Bluetooth network;

FIG. 2 shows a control procedure of the Bluetooth network according to the invention;

FIG. 3 is a block diagram of a control device structure according to the invention; and

FIG. 4 shows a network arrangement according to one embodiment of the invention.

### DETAILED DESCRIPTION OF THE INVENTION

In the following, the invention will be described by way of example on the basis of the Bluetooth technology. However, the invention is not restricted to that technology only, but the invention can be applied to any system which employs low-power radio frequency connections for interconnecting various electronic devices. These technologies include e.g. HomeRF and wireless local area networks based on the IEEE 802.11 standard.

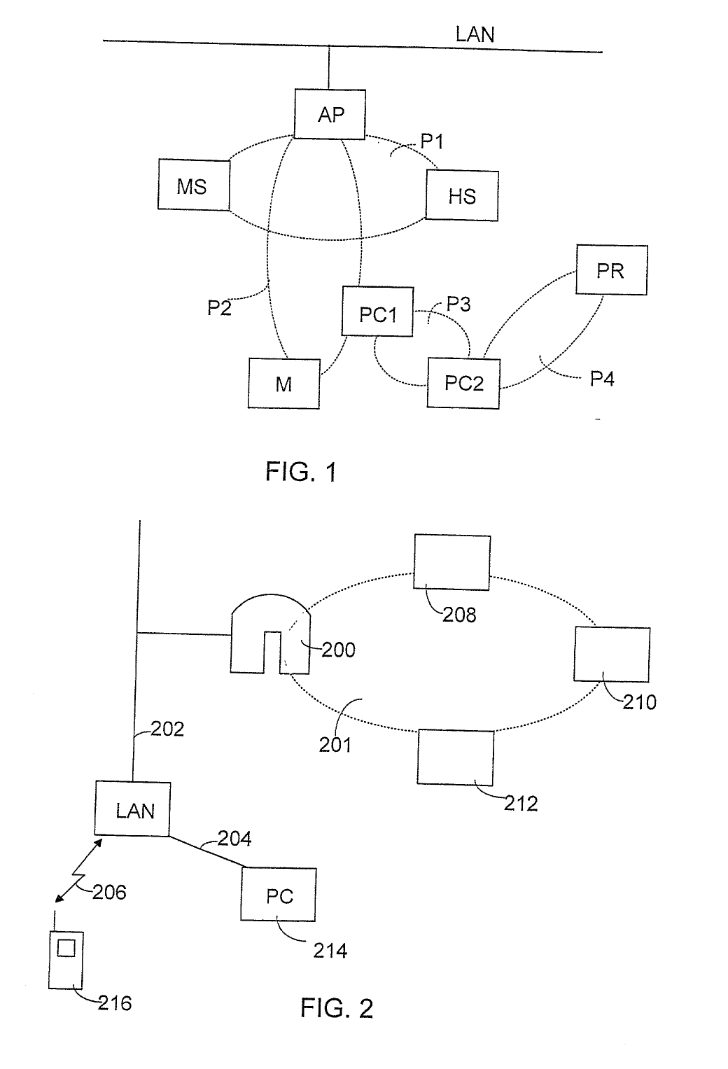

Operation of a Bluetooth network is described here below with reference to FIG. 1, which shows a Bluetooth network comprising a plurality of piconets. Within the service range of a Bluetooth radio transmitter two or more Bluetooth devices can constitute a network entity that is called a piconet. All Bluetooth devices are equal within the network, but the first device transmitting data in the network becomes a master, whose slaves all the other devices in the network are. Clock frequencies of the slaves are synchronized with that of the master. However, the devices can change roles such that a slave becomes a new master whose slaves the old master and the other devices in the network are. However, the piconet can only have one master at a time.

In the Bluetooth network of FIG. 1, a first piconet P1 comprises a mobile station MS, a wireless receiver/microphone headset HS and an access point AP for providing a telecommunication connection, for instance, via a local area network LAN further to other telecommunication networks, such as the Internet and various telephone and mobile networks. So, it is possible to arrange e.g. mobile connections to be handled within the service range of the Bluetooth network such that the mobile station MS establishes a Bluetooth connection to an access point AP, through which a connection is established further to a mobile network. The mobile station MS can also be left in a desktop charger and the call can be switched to the portable headset HS on the user also over the Bluetooth connection. Thus, in the piconet P1 the mobile station MS serves as a master whose slaves the access point AP and the headset HS are. If the headset HS comprises means for starting a call setup, the roles can be changed in the network such that it becomes a new master when the call is set up. Correspondingly, in the case of an arriving call, the access point AP can also serve as the master. Thus, the user of the mobile station can move about freely e.g. in the office area with the headset HS alone and she/he is still able to establish a connection to the mobile network.

Bluetooth employs the internationally non-regulated frequency range of about 2.45 GHz, at broadest 2400 to 2483.5 MHz, in some countries being limited to the range of 2471 to 2497 MHz. Bluetooth data transmission employs frequency hopping based on a spread spectrum technique, and the transmission band is divided into 1 MHz sub-bands which serve as hopping frequencies. Depending on the whole frequency band, there are either 79 or 23 sub-bands in use. The maximum capacity of an asynchronous connection is 721 kbit/s in one direction, and thus a channel of 57.6 kbit/s remains for a return connection. Bluetooth also supports at most three simultaneous synchronous speech channels, of which each can have a capacity of 64 kbit/s. A packet-switched channel is also time divisional (TDD), the length of one time slot being 0.625 ms, during which one packet is transmitted. Thereafter, transmission is changed onto another sub-band and a next packet is transmitted. Frequency is thus changed 1600 times a second.

Prior to establishing the first connection to the Bluetooth network all devices are in a standby mode. Each device then listens at 1.28 second intervals if there are any messages for it. The device scans all the hopping frequencies dedicated to it, typically 32 different frequencies, from which it searches either inquiry or paging messages, the first of which is used when the existence of the device is not known in advance. The device starting connection establishment, which becomes the master at least at the beginning, transmits a paging message at 16 different hopping frequencies. If the messages are not replied to, the same paging message is transmitted on the remaining 16 hopping frequencies. Thus the maximum time, in the course of which the master device reaches the slave devices is 2.56 seconds.

The 1 MHz channel is divided between all the piconet users, and all the users follow the same frequency hopping pattern. Thus, as the number of users increases, the user-specific transmission capacity decreases rapidly to a few tens of kilobits a second. However, only a minority of the Bluetooth devices within the same area exchange information with one another. This problem is solved by an arrangement of FIG. 1, in which only the Bluetooth devices that exchange information with one another belong to the same piconet. In addition to the first piconet PI, the Bluetooth network of FIG. 1 also comprises a second, a third and a fourth piconet P2, P3 and P4. The second piconet P2 also comprises an access point AP and a portable computer PC1 and a wireless mouse M for controlling the computer. The device can thus belong to several piconets at the same time, as the access point AP does in this case. In addition to the above-mentioned portable computer PC1, the third piconet P3 comprises a second portable computer PC2, which communicate with one another. In the fourth piconet, the second portable computer PC2 conveys information with a printer PR. In this manner, each device is in the same piconet only with those devices that are necessary, whereby transmission rates within each piconet can be increased. The Bluetooth network consisting of a plurality of piconets is called a scatternet.

According to one embodiment of the invention, the control device of the invention enables control of the devices attached to the Bluetooth network and reception of information included therein with a terminal device that is located beyond the range of the Bluetooth network. The control device according to the invention, which comprises a Bluetooth module, serves as the master in the Bluetooth network by which slave devices attached to the same Bluetooth network are controlled. The control device according to the invention also comprises means for establishing a telecommunication connection to a telecommunication network, through which connection the device and the other devices of the Bluetooth network subordinated thereto can be controlled and information can be received therefrom by remote access. The control device of the invention thus advantageously acts as a gateway between the Bluetooth network and the external telecommunication network. The control device of the invention further comprises processing means and software means for rendering the control data of the Bluetooth network devices into a format required by various graphic browser specifications.

From the viewpoint of radio technology, use of low-power radio networks is advantageous, because the total transmission power of the networks can be kept low, and consequently interference caused to other devices using the same frequency range remain low. However, wireless remote control of a network of this type has drawbacks, particularly as the low-power networks become more and more common: the remote control cannot be carried out on the same frequency range, and therefore the Bluetooth network devices must be provided with separate wireless call setup means. The bandwidth used in more extensive wireless connections, which are typically arranged via public mobile networks, is typically narrower, which limits data transmission rate, and a separate establishment of connection to each Bluetooth device would produce more mutual interference in the devices. These drawbacks can be advantageously avoided by the control device of the invention, in which a connection to an external controlling terminal is established in a centralized manner via the control device which thus serves as a gateway between the low-power radio frequency network and the external telecommunication network. Thus, the remote control can also be readily arranged wirelessly, when necessary.

In the following, the operation of the control device according to the invention will be described with reference to FIG. 2. In FIG. 2, the control device 200 of the invention has a wired connection to a telecommunication network 202, which in FIG. 2 is e.g. an Ethernet-based, wired local area network with further connections to public wired 204 or wireless 206 networks. The public wired network can be e.g. a telephone network (PSTN/ISDN) or an ADSL (Asynchronous Digital Subscriber Line) connection. The wireless telecommunication network can be e.g. a mobile network, such as the GSM or UMTS network. Advantageously, the control device of the invention can also be attached directly to said wired or wireless networks without a local area network therebetween.

Within the range of the control device 200, the same Bluetooth network 201 comprises a Bluetooth enabled camera 208, a Bluetooth enabled temperature detector 210 and a Bluetooth enabled door-locking controller 212. The Bluetooth network of this kind can advantageously be used for various control and security arrangements e.g. in homes, offices and public premises, such as museums. The control device 200 acts as a master in the Bluetooth network 201 and conveys control data to said other, subordinated devices. Correspondingly, the master 200 receives from other devices various observation data, such as still images or video data taken by the camera 208 or temperature data measured by the temperature detector 210. It is obvious that the network 201 of FIG. 2 can also comprise any Bluetooth devices, and the number of said devices is not limited by anything else but the general capacity of the Bluetooth network.

The Bluetooth network controlled in accordance with the invention can advantageously be utilized in various control and security arrangements. In prior art wired security and detection systems the location of control devices is typically fixed, which causes security risks due to misuse of the system or which limits versatile use of the detection system. In the Bluetooth network according to the invention the location of the control cameras or detectors can be changed, if necessary, whereby it is possible to make the control system less vulnerable to external misuse. Correspondingly, the placement of detectors used for measuring physical variables, such as temperature, can be changed such that the detection of variables in a particular space can be performed from new points or a completely new detection system can be created in a new space with the same detectors. By means of the control device according to the invention it is possible to create rapidly a temporary, so-called ad hoc network, which can be attached to external telecommunication networks and through them to the controlling remote terminal in accordance with the invention.

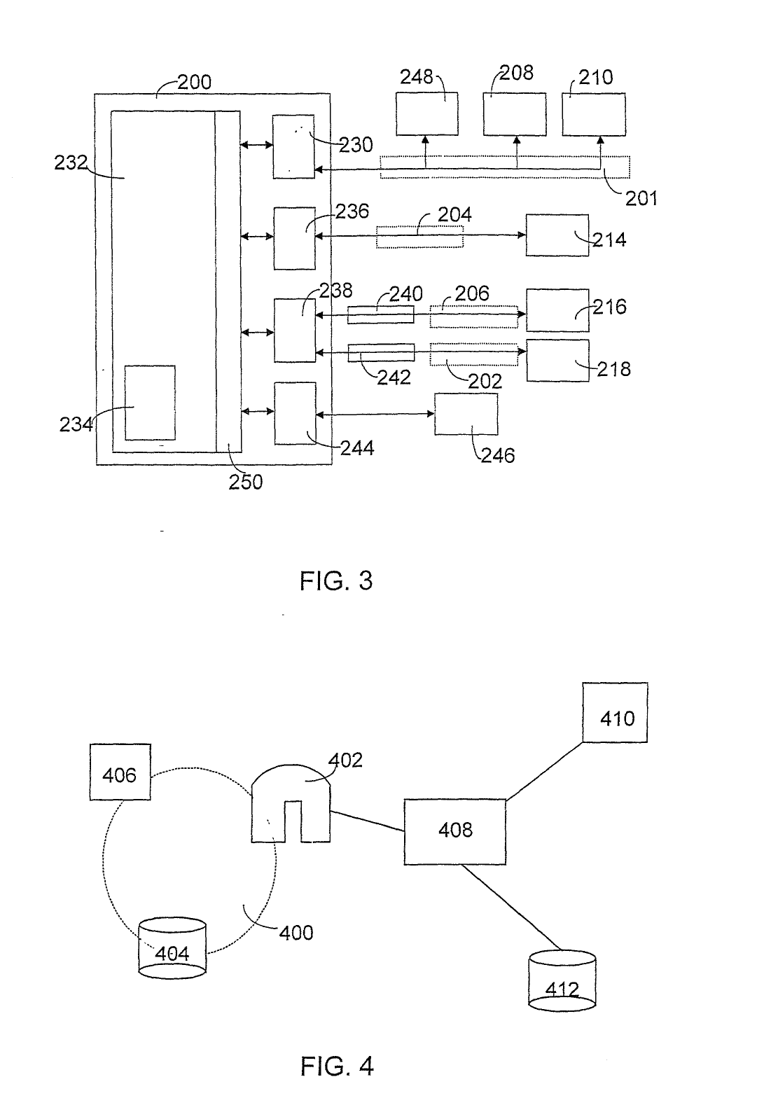

In the following, the structure of the control device 200 according to the invention is described in greater detail with reference to FIG. 3. The control device comprises a Bluetooth module 230 for establishing a connection to the devices in the Bluetooth network 201. The control device 200 further comprises an operating system implemented by means of software with a microprocessor and sufficient memory and software applications 232 arranged thereto. According to one embodiment the device 200 also comprises, as part of software applications 232, processing means and software means 234 for rendering the control data of the Bluetooth network devices into a format required by various graphic browser specifications. Thus, the device 200 converts said control data and detection data according to predetermined specifications, for instance, into HTML language (HyperText Mark-up Language), XML language (Extensible Markup Language) or WML language (Wireless Mark-up Language) format, whereby a hypertext-based browser page becomes the user interface of the device 200.

The control device 200 comprises means for establishing a telecommunication connection to a telecommunication network, via which connection control data conveyed and detection data received by the device 200 can be controlled by a remote terminal. The means for establishing a communication to the telecommunication network may preferably comprise a telephone network adapter 236, which can preferably be an integrated modem, or a mobile network interface card 240, such as that of the GSM network, to be attached to an expansion bus 238, preferably to PCMCIA expansion slot, or a local area network interface card 242. The connection is established via the external telecommunication network connection to a remote terminal, which can be a home computer 214 communicating over the telephone network with the Internet, or a mobile network terminal 216. The connection can also be established directly to an Internet service provider or to a company intranet 218 via the local area network 202. The control and detection data of the control device 200 can be controlled from the remote terminal, for instance by means of a WWW-connection established from the home computer 214 or by means of a WAP connection established from a WAP (Wireless Application Protocol) mobile station 216.

The control device 200 can also comprise connecting means 244, such as a serial port bus, to a local terminal 246, whereby the control of the Bluetooth network 201 can be arranged locally, for instance, if connections to external telecommunication networks are not available. Correspondingly, the local control can be arranged by means of a local terminal 248 attached to the Bluetooth network. Further, the control device 200 preferably comprises identification means 250 for identifying the connection established by the terminal and it modifies the user interface employed to a format required by the connection. For instance, in response to a WAP connection established by the WAP mobile station 216 the device 200 automatically converts the user interface into WML format.

The above-described connecting means for establishing a connection to the terminal can be implemented either as separate attachable modules or they can be integrated into the control device 200. The control device 200 may comprise a plurality of the above-described connecting means, and the intra-device configuration defines which bus is used for which purpose. A default bus can be set for the device, through which bus connections to the external network are established, but the user interface advantageously comprises a function to change the settings, when necessary.

According to one preferred embodiment, the control device 200 provides means for establishing connection to the Internet for the devices attached to the Bluetooth network 201, such as portable computers or mobile stations. The connection is established from the control device to an Internet service provider via an external telecommunication network, preferably at the request of a slave device of the Bluetooth network. Because only the control device has a determined IP address, the established Internet connection can advantageously be shared between several devices of the Bluetooth network. The first connection request to any Internet address actually opens a data transmission connection to an Internet service provider, to which data transmission connection the other Bluetooth network devices can attach and virtually open their own connection, in other words, several simultaneous connections. The connection to the service provider is maintained as long as any of the virtual connections is active and the connection will be disconnected as the last virtual connection is disconnected.

The user interface of the control device 200 is thus advantageously formed in accordance with a graphic browser specification, such as HTML language, and the user interface is operated by means of a terminal attached directly (in a wired manner, or in the Bluetooth network, wirelessly) to the control device, or by means of the above-described remote terminal. The user interface of the control device 200 comprises a configuration function, by means of which the other Bluetooth network devices can be connected, for instance, when the control device 200 is taken into use for the first time. The identification data of other slave devices can advantageously be stored in the memory of the control device 200, whereby the Bluetooth network is immediately ready to receive control commands as the remote terminal connection is established. Further, the user interface of the control device 200 comprises an authentication function, by which unknown devices are prevented from attaching to said Bluetooth network and unknown remote terminals are prevented from establishing unauthorized connections. The user interface also comprises a function for controlling the settings of various Internet connections and for setting various definitions for virtual Internet connections. Likewise, for various users can be set a user profile, i.e. specific default settings for operating all control device functions.

According to one embodiment of the invention, by means of the device 200, in particular said external module connected thereto, it is possible to switch the wireless calls transmitted in the Bluetooth network, over the Bluetooth protocol, e.g. to a public telephone network PSTN or to be switched as so-called IP calls via the network utilizing the Internet protocol. Either the device 200 or the external module connected thereto advantageously comprises an interworking function (IWF) which converts speech transmitted over a Bluetooth-protocol audio link to a pulse code modulated (PCM) format required by the PSTN or to IP data packets required by the IP calls. Thus, while in the Bluetooth network, the mobile station provided with the Bluetooth module is able to establish calls via the public wired telephone network PSTN, which is less expensive than via the mobile network.

According to one embodiment, the invention can be utilized for call management in a centralized manner e.g. in offices where a plurality of Bluetooth networks are in use. From each network the identification data of the wireless terminals, such as Bluetooth mobile stations, attached to the network via the device 200 are forwarded to the external terminal or to the telephone exchange of the office. On the basis of the wireless devices' identification data and the Bluetooth network data attached thereto, it is possible to switch the incoming calls of the wireless terminals from the telephone exchange directly to a correct Bluetooth network and further to a correct terminal. In practice, inhouse calls between different Bluetooth networks can thus be free of charge.

According to one embodiment, the user, detection and identification data of the Bluetooth network can be stored in separate memory means, which is illustrated by FIG. 4. The data can be stored in the Bluetooth network 400 either in the memory included in the master 402 or in a separate mass memory 404, to which the necessary data of the slaves 406 are conveyed. The desired data can be updated, for instance, at regular intervals or every time changes to be stored take place in the slaves. Thus, it is possible to browse said stored data by a connection to the remote terminal 410 established via an external telecommunication network 408, such as the public switched telephone network.

According to one embodiment, the above-mentioned memory means can also act as a Bluetooth network buffer memory whose data are further stored in an extra-Bluetooth-network memory 412, which can be e.g. a database of an Internet service provider (ISP), whereto a database connection from said buffer memories 402, 404 and preferably an encrypted Internet connection to the remote terminal 410 can be established. Correspondingly, the data included in the buffer memories can be updated in the database 412 e.g. at regular intervals or every time changes take place in the data stored in the buffer memory. Naturally, it is also possible to store the data directly in the external memory without storing them in the buffer memory, or the data can simultaneously be stored in the buffer memory serving as a local memory and in the external memory. The data in the database 412 can preferably be browsed by the remote terminal 410 in an interactive manner such that the control commands from the remote control are first updated in the database 412 and then transmitted via a database connection to the Bluetooth network. This advantageously avoids the bottlenecks e.g. in transmission rate in the direct telecommunication connection between the remote terminal and the Bluetooth network. In addition, this arrangement and the use of encrypted telecommunication connections improves information security. This becomes clear in particular when the same party controls a plurality of Bluetooth networks, possibly from the same remote terminal. Thus, the data on each network collected to the external database and used in an interactive manner are easily accessible in a centralized manner and information security is considerably improved in comparison with a solution wherein a separate connection is established to each control device.

According to one embodiment, the device 200 can be used as a common Bluetooth access point in accordance with FIG. 1, whereby the device 200 provides e.g. a portable computer or a personal digital assistant (PDA) with a wireless connection further to various networks, such as a company-based local area network.

It is obvious to the person skilled in the art that as technology advances the basic idea of the invention can be implemented in a variety of ways. The invention and its embodiments are thus not restricted to the above-described examples but they may vary within the scope of the claims.

1. A method for controlling a wireless, low-power radio frequency network, which comprises a master device and at least one slave device subordinated thereto, the master device being configured to convey control data to said at least one slave device and to receive detection data from said at least one slave device, the method comprising
establishing a data transmission connection between the master device and an external terminal via a second telecommunication network,
arranging said received detection data in the master device into a format required by a transmission protocol used in said transmission connection for being conveyed to said external terminal, and
conveying control data from said external terminal device to the master device in the format required by the transmission protocol used in said transmission connection for controlling said at least one slave device.

2. A method as claimed in claim 1, further comprising
arranging in the master device said detection data into a format required by a graphic browser specification, such as HTML or WML, and
controlling devices subordinated to the master device from a hypertext page according to said graphic browser specification by the external terminal.

3. A method as claimed in claim 1, further comprising
establishing an Internet connection from said at least one slave device via the master device and the external telecommunication network.

4. A method as claimed in claim 3, further comprising
using the Internet connection established by the master as a Internet connection shared between a plurality of devices in response to a second slave device establishing an Internet connection.

5. A method as claimed in claim 1, further comprising
authenticating in the master device said slave devices and the external terminal in response to the first connection establishment to the master device.

6. A method as claimed in claim 1, further comprising
converting wireless voice calls between the master device and said at least one slave device into a voice call format of an external telecommunication network in the master device to be transmitted beyond the low-power network and
converting a call of an external network format voice call destined for said at least one slave device in the master device to be transmitted wirelessly in the voice call format of the low-power network.

7. A method as claimed in claim 6, further comprising
collecting identification data of the slave devices of at least one wireless low-power radio frequency network to said terminal and
controlling the call from the terminal to a slave device to be routed to the corresponding radio frequency network on the basis of said identification data.

8. A method as claimed in claim 1, further comprising
establishing a data transmission connection between the master device and an external storing means,
storing said detection data in said external storing means, establishing an interactive data transmission connection between said external storing means and said external terminal, and
updating control data for said external storing means and master device in response to said external terminal conveying control data to said external storing means.

9. A method as claimed in claim 8, further comprising
storing said detection data also in a buffer memory of the lowpower radio frequency network.

10. A wireless low-power radio network control device, which is configured to be a network master device and to convey control data to at least one slave device belonging to said network and to receive detection data from said at least one slave device, the control device comprising
means for establishing a telecommunication connection to an external terminal via a second telecommunication network,
means for arranging said detection data into a format required by the data transmission protocol used in said data transmission connection, and means for handling the control data received from said external
terminal and for forwarding them to said at least one slave device.

11. A control device as claimed in claim 10, wherein the control device further comprises
means for arranging said detection data into a format required by a graphic browser specification, such as HTML or WML, and
means for controlling the slave devices according to commands received from the external terminal's hypertext page according to said graphic browser specification.

12. A control device as claimed in claim 10, wherein the control device further comprises
means for establishing a telecommunication connection to a plurality of external telecommunication networks which networks comprise at least some of the following: a public wired telephone network (PSTN/ISDN), a public mobile network (GSM, UMTS) an ADSL network, a local area network.

13. A control device as claimed in claim 12, further comprising
means for establishing an Internet connection to said at least one slave device via said radio network and external telecommunication network.

14. A control device as claimed in claim 13, further comprising
means for sharing said Internet connection between a plurality of devices in response to a second slave device requesting for an Internet connection.

15. A control device as claimed in claim 10, further comprising
authenticating means for identifying said slave devices and external terminals in response to their first connection establishment to the control device.

16. A control device as claimed in claim 10, further comprising
converting means for converting voice calls between the control device and said at least one slave device into a voice call format of an external telecommunication network to be conveyed beyond said low-power network, and
converting means for conveying a call, which is in a voice call format of an external telecommunication network and destined for at least one slave device, wirelessly into a converted voice call format of said low-power network.

17. A control device as claimed in claim 10, further comprising
connecting means for attaching a local terminal in a wireless or wired manner to the control device, by which terminal it is possible to control the control device according to commands from the hypertext page according to the graphic browser specification.

18. A control device as claimed in claim 17, wherein
the means for establishing an external or local terminal connection are either integrated in the control device or implemented as attachable modules.

19. A control device as claimed in claim 10, wherein the control device is configured
to establish a data transmission connection to the external storing means,
to store said detection data in said external storing means, and
to update control data transmitted from said external terminal via said external storing means.

20. A control device as claimed in claim 19, wherein the control device is further configured
to store said detection data in a buffer memory included in said lowpower radio frequency network.
